(19) United States
(12) Patent Application Publication
(10) Pub. No.: US 2015/0158171 A1
(43) Pub. Date: Jun. 11, 2015

(54) SLIDE-ON GRIP FOR OBJECTS HAVING A HANDLE

(71) Applicant: Mick B. SAUNDERS, Plainwell, MI (US)

(72) Inventor: Mick B. SAUNDERS, Plainwell, MI (US)

(21) Appl. No.: 14/098,734

(22) Filed: Dec. 6, 2013

(51) Int. Cl. B25G 1/10; B25G 1/02

(52) U.S. Cl. CPC B25G 1/102; B25G 1/02

(57) ABSTRACT

An elongate hollow sleeve-like grip having a bore with a plurality of protuberances provided on the interior thereof, each protuberance having a circumference and a tapering outer surface extending from a location adjacent the wall surface of the bore toward a distal end thereof whereat the distal end is a smoothly shaped dome-like surface structure. Each protuberance is configured to engage the outwardly facing surface of an object handle having an outwardly facing surface that is larger in diameter than a radial spacing between mutually adjacent axially and circumferentially spaced dome-like surface structures to cause a flexing of the material of the grip to facilitate the dome-like surface structures and the tapering circumferential surfaces thereof to engage the outwardly facing outer surface of the handle to allow a position of the body on the handle to be moved at least one of lengthwise and rotated relative to the handle.

### FIELD OF THE INVENTION

This invention relates to a slide-on grip for an object having an elongate handle with an outwardly facing generally cylindrical surface.

### BACKGROUND OF THE INVENTION

Numerous slide-on grip devices are known and one example is set forth in U.S. Pat. No. 5,860,190. This patent discloses the provision of concave features or dimples and spiral grooves in the interiorly facing wall of the grip. These feature limit air access between the surface of the object being gripped and the interiorly facing wall of the grip to thereby limit and/or make very difficult any adjustment of the position of the grip relative to the object being gripped. Accordingly, it is desirable to provide a grip having structure providing an air gap between the surface of the object being gripped and the interiorly facing wall to facilitate ease of installation, adjustment and removal of the grip from the object

The objects and purposes of the invention are to provide a grip that is easily manipulated into position, and/or reposition while maintaining steady positive frictional gripping pressure and to serve as a grip, cushion, float or protective sleeve onto or over any handle of an implement or stud-like protrusion.

It is another object of the present invention to provide a flotation device for certain objects used around water, such as fishing rods, gaffs, nets, boathooks, etc.

It is another object of the present invention to provide a grip facilitating cushioning and comfort to the hands, under the arm or other body parts and prevent or at least minimize sudden shock loads impacting the body from outside forces on the grip and to minimize fatigue from extended usage of an implement equipped with the aforesaid grip.

It is another object of the present invention to provide protection to persons from accidental contact with force against blunt ends of protruding type objects, such as exposed reinforcing steel on construction sites.

It is another object of the present invention to provide protection cushioning against machined protruding surfaces from damaging other objects or surfaces, such as fishing rod butts damaging boat decks and to provide a gripping of implements with the grip thereon with boat decks and minimizing the movement of the aforesaid implements around on the deck.

It is another object of the present invention to provide protection for valuable machined protruding surfaces from damaging forces coming from other hard surfaces.

### SUMMARY OF THE INVENTION

The objects and purposes of the invention are met by providing an elongate hollow sleeve-like grip made of elastically yieldable material configured for use with an object having an elongate handle with an outwardly facing generally cylindrical surface. The body has a first longitudinal axis and a radially outwardly facing surface. A bore extends coextensively with the length of the body and opening outwardly at least at one axial end thereof. The bore has a second longitudinal axis extending coextensive with the first longitudinal axis of the sleeve-like body and an interiorly facing wall surface, a difference in diameters of the outwardly facing surface and the interiorly facing wall surface defining a wall thickness of the body. A plurality of independently oriented axially and circumferentially spaced protuberances integrally provided on the interiorly facing wall surface and projecting radially inwardly toward a central region of the bore, each of the protuberances having a circumference and a tapering outer surface extending from a location adjacent the interiorly facing wall surface toward a distal end thereof whereat the distal end is a smoothly shaped dome-like surface structure, each protuberance being configured to engage the outwardly facing surface of the handle having an outwardly facing surface that is larger in diameter than a radial spacing between mutually adjacent axially and circumferentially spaced dome-like surface structures to cause at least one of the wall thickness of the body and the protuberances to yield to facilitate the dome-like surface structures and the tapering circumferential surfaces thereof to engage the outwardly facing outer surface of the handle to allow a position of the body on the handle to be moved at least one of lengthwise and rotated relative to the handle.

### BRIEF DESCRIPTION OF THE DRAWING

Other objects and purposes of the invention will be apparent to persons acquainted with apparatus of this general type upon reading the following specification and inspecting the accompanying drawings, in which:

FIG. 1 is an isometric longitudinal sectional view of a first embodiment of my slide-on cushion that embodies the invention;

FIG. 2 is a sectional view taken along the line 2-2 of FIG. 1;

FIG. 3 is a side view of my slide-on cushion;

FIG. 4 is an end view of FIG. 3;

FIG. 5 is a sectional view taken along the line 5-5 of FIG. 4;

FIG. 6 is a sectional view taken along the line 6-6 of FIG. 5;

FIG. 7 is an isometric longitudinal sectional view of a second embodiment of my slide-on cushion that embodies the invention;

FIG. 8 is a sectional view taken along the line 8-8 of FIG. 7;

FIG. 9 is a side view of my slide-on cushion;

FIG. 10 is an end view of FIG. 3;

FIG. 11 is a sectional view taken along the line 11-11 of FIG. 10;

FIG. 12 is a sectional view taken along the line 12-12 of FIG. 11;

FIG. 13 is an enlargement of one protuberance;

FIG. 14 is a third embodiment of a sleeve-like body having a closed end;

FIG. 15 is a fourth embodiment of a sleeve-like body having a bulbous structure defining a closed end; and

FIG. 16 is a fifth embodiment similar to FIG. 15 except that the bore within the bulbous structure is tapered toward the closed end.

### DETAILED DESCRIPTION

Certain terminology will be used in the following description for convenience in reference only and will not be limiting. The words “up”, “down” “right” and “left” will designate directions in the drawings to which reference is made. The words “in” and “out” will refer to directions toward and away from, respectively, the geometric center of the device and designated parts thereof. Such terminology will include derivatives and words of similar import.

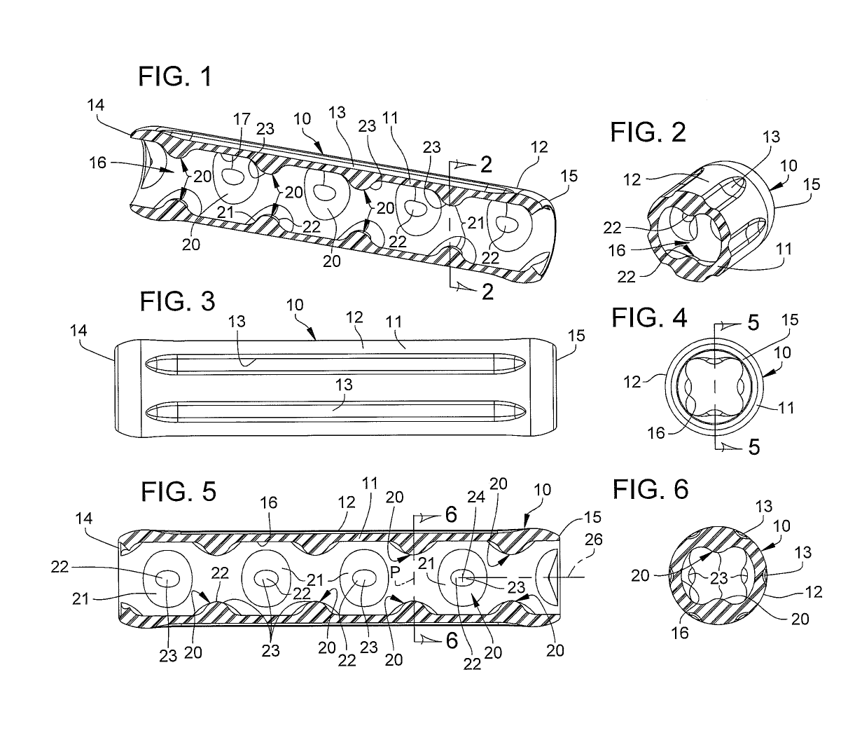

FIGS. 1-6 illustrate a first embodiment of an elongate slide-on grip 10 for use with an object (not shown), such as a leaf rake, a shovel, a butt end of a fishing rod and the like, having an elongate handle with an outwardly facing generally cylindrical surface. The grip 10 has a generally cylindrical shaped sleeve-like body 11 having a radially outwardly facing surface 12 with a plurality of circumferentially spaced longitudinally extending flutes 13 extending between the axial ends of the grip 10. Opposite terminal ends of each of the flutes 13 terminate a finite distance from the axial ends 14 and 15 of the grip 10. The body 11 of the grip 10 has a central through-bore 16 opening outwardly at both axial ends 14 and 15. The through-bore 16 has a radially inwardly facing or interiorly facing wall surface 17.

A plurality of independently oriented axially and circumferentially spaced protuberances 20 are integrally provided on the interiorly facing wall surface 17 and projecting radially inwardly toward a central region of the through-bore 16. Each of the protuberances 20 has a round tapering circumference, such as an oval or circular cross-sectional shape, and a tapering and smooth outer surface 21 extending from a location adjacent the interiorly facing wall surface 17 toward a distal end 22 thereof whereat the distal end is a smoothly shaped dome-like surface structure 23. When the round shape is oval, the major axis of the oval extends circumferentially of the through-bore 16. Each protuberance 20 has a central radially extending axis central axis 24 and each axis 24 lies in a common plane P that is perpendicular to a central longitudinal axis 26 of the through-bore 16. The cross-section of each protuberance can also be other than circular or oval, such as any polygon shape and the tapering sides of the polygon converge to either a dome-like surface structure or converge at a point. In addition, the central longitudinal axis 26 of the through-bore 26 is congruent with the central axis of the sleeve-like body 11.

In the embodiment of FIGS. 1-6, the central axis 24 of axially spaced groups of two protuberances 20 are diametrically spaced from one another and the distal ends 22 of each are equidistantly spaced from the central longitudinal axis 26. The two protuberances 20 in each mutually adjacent group are oriented at a circumferentially spaced location, such as a 90° angle. If there is to be more than two such protuberances 20 in each group, each protuberance 20 in each group is equidistantly spaced from one another and the distal ends 22 are each equidistantly spaced from the central longitudinal axis 26.

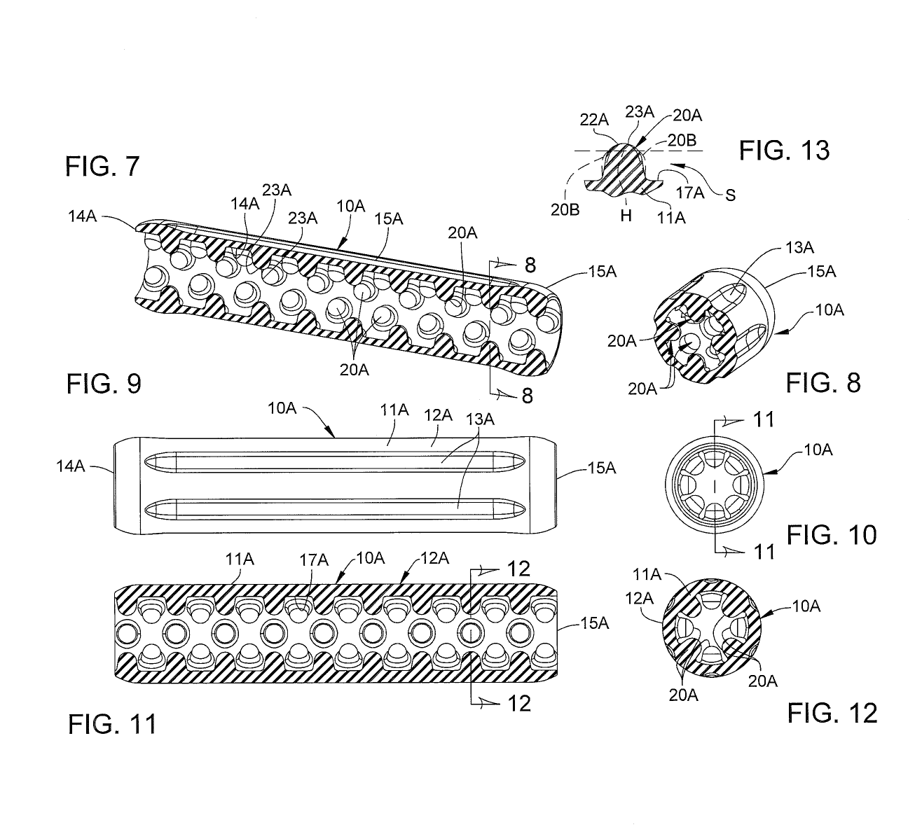

FIGS. 7-13 illustrate a second embodiment of a grip embodying my invention. The same reference numbers used in describing the FIGS. 1-6 embodiment will be used in describing similar structure in the FIGS. 7-13 embodiment but with the suffix “A” added thereto.

The primary distinction between the embodiment of FIGS. 1-6 and the embodiment of FIGS. 7-13 is the outer diameter of the radially outwardly facing surface 11A of the grip 10A. To accommodate the larger outer diameter while maintaining a similar wall thickness of the material of the grip, the protuberances 20A are longer than the protuberances 20A

More specifically, the grip 10A has a generally cylindrical shaped sleeve-like body 11A having a radially outwardly facing surface 12A with a plurality of circumferentially spaced longitudinally extending flutes 13A extending between the axial ends of the grip 10A. Opposite terminal ends of each of the flutes 13A terminate a finite distance from the axial ends 14A and 15A of the grip 10A. The body 11A of the grip 10A has a central through-bore 16A opening outwardly at both axial ends 14A and 15A. The through-bore 16A has a radially inwardly facing or interiorly facing wall surface 17A.

A plurality of independently oriented axially and circumferentially spaced protuberances 20A are integrally provided on the interiorly facing wall surface 17A and projecting radially inwardly toward a central region of the through-bore 16A. Each of the protuberances 20A has a round tapering circumference, such as an oval or circular cross-sectional shape, and a tapering and smooth outer surface 21A extending from a location adjacent the interiorly facing wall surface 17A toward a distal end 22A thereof whereat the distal end is a smoothly shaped dome-like surface structure 23A. When the round shape is oval, the major axis of the oval extends circumferentially of the through-bore 16A. Each protuberance 20 has a central radially extending axis central axis 24A and each axis 24A lies in a common plane P that is perpendicular to a central longitudinal axis 26 of the through-bore 16A.

In the embodiment of FIGS. 7-13, there are four protuberances 20A provided in each group of several axially spaced groups along the interior of the through-bore 16A. The central axis 24A of pairs of protuberances 20A in each axially spaced group of four protuberances 20A are diametrically spaced from one another and the distal ends 22A of each are equidistantly spaced from the central longitudinal axis 26A. The four protuberances 20A in each mutually adjacent group are oriented at a circumferentially spaced location, such as a 90° angle from each adjacent group. Each protuberance 20A in each group is equidistantly spaced from one another and the distal ends 22A are each equidistantly spaced from the central longitudinal axis 26A.

The unitary grips 10 and 10A are each made of an elastic material that is capable of retaining its shape during use and having an outer surface with a high coefficient of friction. In these two particular embodiments, the elastic material is tough and closed-celled flexible foam. This type of foam may be made from materials such as polyvinylchloride, polyurethane, polystyrene, polypropylene, polyethylene, neoprene and mixtures thereof. The foam may be non-reticulated (closed-cell) or reticulated (open-cell), pending upon the softness of the foam and other parameters. In these two particular embodiments, the preferred material is a Vinyl-free Olefin based closed-cell, cross-linked elastomer. The Shore A durometer of the preferred material is in the range of 5 to 50 with the preferred range being 15 to 25.

In use, each protuberance 20 and 20A is configured to engage the outwardly facing surface of the handle that has an outwardly facing surface that is larger in outer diameter than a radial spacing between mutually adjacent axially and circumferentially spaced dome-like surface structures but less than the diameter of the interiorly facing walls 17 and 17A to cause air to have access to the spacing S between the radially outwardly facing surface on the handle H and the interiorly facing walls and, when installing the grip onto the handle, at least one or both of the wall thickness of the sleeve-like body and the protuberances to yield to one of the broken line positions 20B in FIG. 13 to facilitate the dome-like surface structures and/or the tapering circumferential surfaces thereof to engage the outwardly facing outer surface of the handle to allow a position of the sleeve-like body on the handle to be moved at least one of lengthwise and rotated relative to the handle. When the user is not handling the grip, the protuberances will serve the purpose of frictionally maintaining the position of the grip on the handle. When the user is applying a gripping force to the radially outwardly facing surface 12 of the sleeve-like body 11, the material of the grip will squeezed radially inwardly to increase the frictional force of the protuberances against the handle to prevent it from moving relative to the handle during use.

### Alternate Embodiments

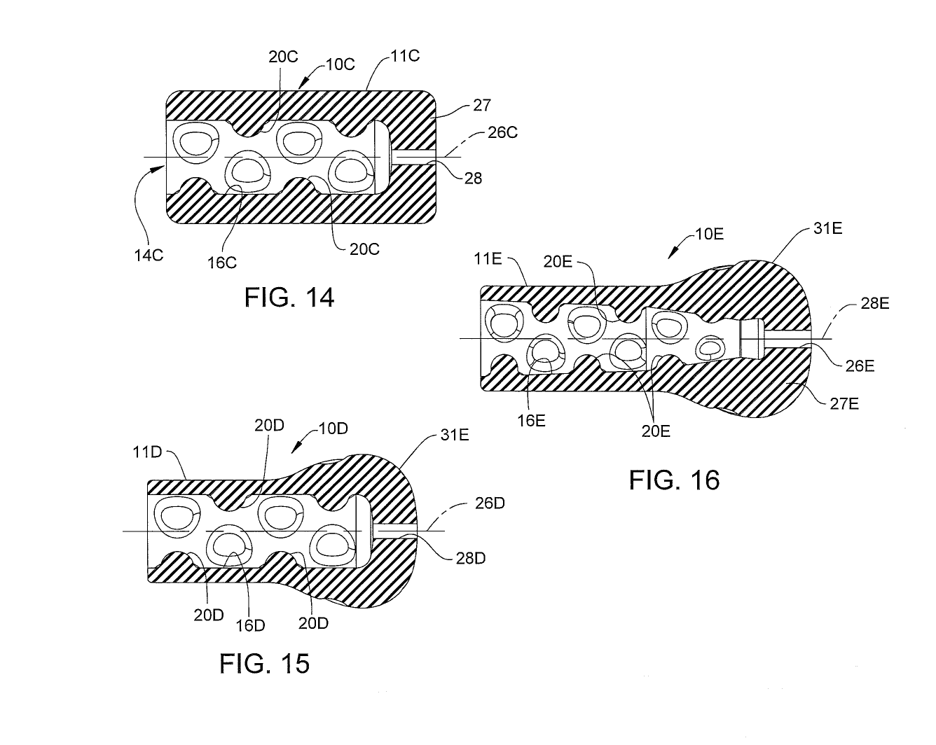

FIG. 14 illustrates an embodiment of a grip 10C having a sleeve-like body 11C, in this case a shorter sleeve-like body, and having a closed end wall 27 at an end of the sleeve remote from the open end 14C. In this embodiment, the closed end wall 27 is flat and lies in a plane that is perpendicular to the longitudinal axis 26 of the bore 16C. The end wall 27 has a small through-hole 28 therein oriented generally coaxial with the longitudinal axis 26 of the bore.

FIG. 15 illustrates an embodiment of a grip 10D having a sleeve like body 11D and a bulbous structure 31 defining a closed end structure at one end of the body 11D. In this particular embodiment, the bore 16D is cylindrical and there is provided a small through-hole at the very end of the bulbous structure remote from the open end of the bore 14D. The axis of the small through-hole is oriented generally coaxial to the longitudinal axis 26D of the bore 16D.

FIG. 16 illustrates an embodiment of a grip 10E that is similar to the embodiment of FIG. 15 except that bore 16E is hourglass shaped and particularly is tapered so as to become more narrow from the open end through the sleeve part toward and into the bulbous structure 31E. The end of the bore 16E expands in diameter toward the bottom end of the bore. Furthermore, the radial spacing of the distal ends 22E of the protuberances with the bulbous structure from the longitudinal axis 26E of the bore 16E are less than the radial spacing of the distal ends within the sleeve-like body 11E.

Although particular preferred embodiments of the invention have been disclosed in detail for illustrative. purposes, it will be recognized that variations or modifications of the disclosed apparatus lie within the scope of the present invention.

I claim:

1. An elongate hollow sleeve grip made of elastically yieldable material configured for use with an object having an elongate handle with an outwardly facing generally cylindrical surface having a first diameter, comprising:
an elongate hollow sleeve-like body having a first longitudinal axis and a radially outwardly facing surface, a bore extending coextensively with the length of said sleeve-like body and opening outwardly at least at one axial end thereof, said bore having a second longitudinal axis extending coextensive with said first longitudinal axis of said sleeve-like body and an interiorly facing wall surface, a difference in diameters of said outwardly facing surface and said interiorly facing wall surface defining a wall thickness of said sleeve-like body;
a plurality of independently oriented axially and circumferentially spaced protuberances integrally provided on said interiorly facing wall surface and projecting radially inwardly toward a central region of said bore, each said protuberance having a circumference and a tapering outer surface narrowing from a location adjacent said interiorly facing wall surface toward a distal end thereof and a distal end structure, each distal end structure having a radial spacing from said second longitudinal axis that is less than said first diameter whereby each protuberance will engage the outwardly facing surface of the handle while leaving an air gap between said interiorly facing wall surface and the outwardly facing surface of the handle to cause at least one of said wall thickness of said sleeve-like body and said protuberances to yield to facilitate said distal end structures and said tapering circumferential surfaces thereof to engage the outwardly facing outer surface of the handle to allow a position of said sleeve-like body on the handle to be moved at least one of lengthwise and rotated relative to the handle.

2. The elongate hollow sleeve grip according to claim 1, wherein at least a plurality of said protuberances are circular in cross-section.

3. The elongate hollow sleeve grip according to claim 1, wherein at least a plurality of said protuberances are oval in cross-section, a major axis of the oval extending in a circumferential direction of said bore.

4. The elongate hollow sleeve grip according to claim 1, wherein at least one pair of protuberances is oriented to oppose one another in a diametrically spaced orientation in said through-bore.

5. The elongate hollow sleeve grip according to claim 1, wherein each protuberance has a radially extending central axis and wherein central axes of plural protuberances lie in a common plane that is perpendicular to said second longitudinal axis.

6. The elongate hollow sleeve grip according to claim 5, wherein one pair of protuberances lie in said common plane, said distal end of each protuberance being equidistantly spaced from said second longitudinal axis.

7. The elongate hollow sleeve grip according to claim 5, wherein one pair of protuberances lie in said common plane, said central axis of each said protuberance being axially aligned with each other and said distal end of each protuberance being equidistantly spaced from said second longitudinal axis.

8. The elongate hollow sleeve grip according to claim 5, wherein two pairs of protuberances lie in said common plane, said distal end of each protuberance being equidistantly spaced from said second longitudinal axis.

9. The elongate hollow sleeve grip according to claim 5, wherein two pairs of protuberances lie in said common plane, central axes of each pair of said protuberances being axially aligned with each other and said distal end of each protuberance being equidistantly spaced from said second longitudinal axis.

10. The elongate hollow sleeve grip according to claim 5, wherein plural protuberances are oriented in plural groups along the interior of said through-bore, each protuberance in each group lying in said common plane, said distal end of each protuberance being equidistantly spaced from said second longitudinal axis and equidistantly spaced from each other.

11. The elongate hollow sleeve grip according to claim 1, wherein said radially outwardly facing surface of said body has a plurality of longitudinally extending and circumferentially spaced flutes.

12. The elongate hollow sleeve grip according to claim 1, wherein said bore is closed at an axial end remote from said outwardly opening end.

13. The elongate hollow sleeve grip according to claim 12, wherein said closed end is an end wall lying in a plane perpendicular to said second longitudinal axis.

14. The elongate hollow sleeve grip according to claim 12, wherein said closed end is a bulbous structure having an outer diameter greater than said outwardly facing surface of said sleeve-like body, said bore extending into said bulbous structure.

15. The elongate hollow sleeve grip according to claim 14, wherein said bore is tapered and narrowing in diameter within said bulbous structure, a second radial spacing of said distal ends of said protuberance within said bulbous structure being less than said radial spacing of said distal ends within said sleeve-like body.

16. The elongate hollow sleeve grip according to claim 1, wherein said first and second longitudinal axes are congruent.

17. The elongate hollow sleeve grip according to claim 1, wherein said distal end structure is a rounded dome-like surface structure.
